(19) United States
(12) Patent Application Publication
(10) Pub. No.: US 2012/0250865 A1
(43) Pub. Date: Oct. 4, 2012

(54) SECURELY ENABLING ACCESS TO INFORMATION OVER A NETWORK ACROSS MULTIPLE PROTOCOLS

(75) Inventors: Ryan Marcus Terpstra, New York, NY (US); Andrew Lee Brook, Jersey City, NJ (US)

(73) Assignee: Selerity, Inc, Jersey City, NJ (US)

(21) Appl. No.: 13/429,105

(22) Filed: Mar. 23, 2012

Related U.S. Application Data
(60) Provisional application No. 61/466,727, filed on Mar. 23, 2011.

(51) Int. Cl. H04L 9/28; H04L 9/08

(52) U.S. Cl. 380/279; 713/168

(57) ABSTRACT

There is disclosed a method that includes providing encrypted information to a plurality of receiving devices, and transmitting by one of a multicast and broadcast a release key to the plurality of receiving devices to enable access to the encrypted information, wherein the release key is received at or about the same time by the plurality of receiving devices. The release key may be transmitted and or received over a multicast or broadcast network. The release key may be transmitted and/or over a distributed network. The transmission of the release key may be synchronized using a timing mechanism.

### CROSS REFERENCE TO RELATED APPLICATIONS

This application claims the benefit and priority to U.S. Provisional Application No. 61/466,727 filed on Mar. 23, 2011, and is hereby incorporated by reference in its entirety.

### BACKGROUND

The present invention relates to accessing information, and more particularly, to securely accessing information over a network across multiple protocols

Government regulations and regulators generally require that certain information, such as about publicly traded companies, be made available to the public on or about the same time or substantially simultaneously to promote fairness in the marketplace. Such information may include court determinations, corporate earnings, key acquisitions, and product announcements. This type of information may be used by financial professionals and other market participants to make trading and investment decisions.

A publisher of information may display information on their company website, rather than delivering the information. Alternatively, a publisher of information may use social media, such as Facebook® or Twitter®, to provide information. Such sources may lack resources to control the external synchronization of an embargo time for the release. Additionally, if a website is the first disclosure point for a release of information, then investors may poll the website at high speed. Such polling may put a heavy load on the web server, and possibly limit access or shutting down the site. Moreover, such sites may accidentally disclose information prior to its intended release time.

### SUMMARY

Broadly, in one aspect, there is disclosed a method that includes providing encrypted information to a plurality of receiving devices, and transmitting by one of a multicast and broadcast a release key to the plurality of receiving devices to enable access to the encrypted information, wherein the release key is received at or about the same time by the plurality of receiving devices. The release key may be transmitted and or received over a multicast or broadcast network. The release key may be transmitted and/or over a distributed network. The transmission of the release key may be synchronized using a timing mechanism.

In another aspect, there is disclosed a system including one of a File Distribution Server (FDS) and Gateway Server (GWS) configured to receive encrypted information at a file staging time and receive a release key to access the encrypted information at a key release time, wherein the release key is received by one of a multicast or broadcast from a Key Distribution Server (KDS).

In yet another aspect there is disclosed a system including a KDS configured to provide a release key to a plurality of receiving devices, wherein the release key enabling access to encrypted information. One or more switches may be coupled to the KDS and configured to distribute the release key by one of a multicast or broadcast to the plurality of receiving devices. A timing mechanism may be coupled to the KDS and configured to ensure delivery of the release key to the plurality of receiving devices at or about the same time.

### BRIEF DESCRIPTION OF THE DRAWINGS

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1 illustrates an example of a computing device and/or system.

FIG. 2 illustrates a system in accordance with an embodiment.

FIG. 3 illustrates a Key Distribution Server in an embodiment.

FIG. 4 illustrates a web interface in an embodiment.

FIG. 5 illustrates a web interface in an embodiment.

FIG. 6 illustrates a process flow for a release in accordance with an embodiment.

### DETAILED DESCRIPTION

Simultaneous delivery of information may be viewed in multiple ways. In one example, information is transmitted in real-time from a source and received simultaneously or substantially simultaneously at a receiving device. One practical limitation to delivery time in such systems for information is network delay as that information travels from a source to a destination. Network delays may include congestion due to packet loss and blocking. Another issue that may prevent simultaneous delivery of information is latency that may be associated with the delivery of rich data, such as structured data, text, graphics, video or other data. It will be appreciated that the larger the amount of information to be delivered, the more difficult it is to ensure simultaneous delivery to all recipients. It will also be appreciated that if not all sources transmitting information are synchronized, and thus, may transmit information at different times. It will be further appreciated that information sent from a central location will be received by recipients closer to the source of the transmission, before those located further away.

Simultaneous delivery may be also be achieved by providing access to information on or about the same time, even though some or all of the information may have been previously received at a receiving device or recipient. The disclosed systems, methods, apparatus include providing access to information simultaneously or substantially simultaneously to one or more receiving devices or recipients of the information. In one embodiment, a set of encrypted information may be sent to a receiving device and/or recipient prior to the release of information. It should be noted that the terms recipient and receiving device are used interchangeably, and may include a computing device alone and/or a user operating the computing device. A smaller piece of information referred to as a release key may be sent a period of time after the encrypted information using, for example, multicast or broadcast. By using multicast or broadcast to distribute the release key, the aforementioned problems with delivery delays are virtually eliminated. The multicast or broadcast may be performed over a dedicated, local area network. The release key may be received on or about the same time by all recipients. In one embodiment, the release key may be transmitted over a dedicated, low latency multicast or broadcast network. In yet another embodiment, the release key may be transmitted over a distributed network from more than one source at or about the same time. The sources of transmission are synchronized via a timing mechanism at each source. In one embodiment, the release key may be received by a plurality of recipients within milliseconds of each other. The release key may then be used by the recipient to decrypt the information. The decryption may be performed with or without user intervention. In this way, all recipients gain access to the information at or about the same time, thereby promoting fairness in disclosure. The system may be configured to support one or more protocols for the delivery information and/or the release key. For example, the system may use UCP, TCP, HTTP, Twitter®, and Facebook®.

In one embodiment, a publisher may be verified, non-verified, or anonymous. Anonymous publishers may use the system to publish data, but the data is not attributed to the publisher. Non-verified publishers assert their identity and the system may pass that identification onto the recipient, but the system makes no attempt to validate that assertion. Verified publishers are those whose identity has been conclusively determined. The system may indicate which publisher identities have been verified and which have not.

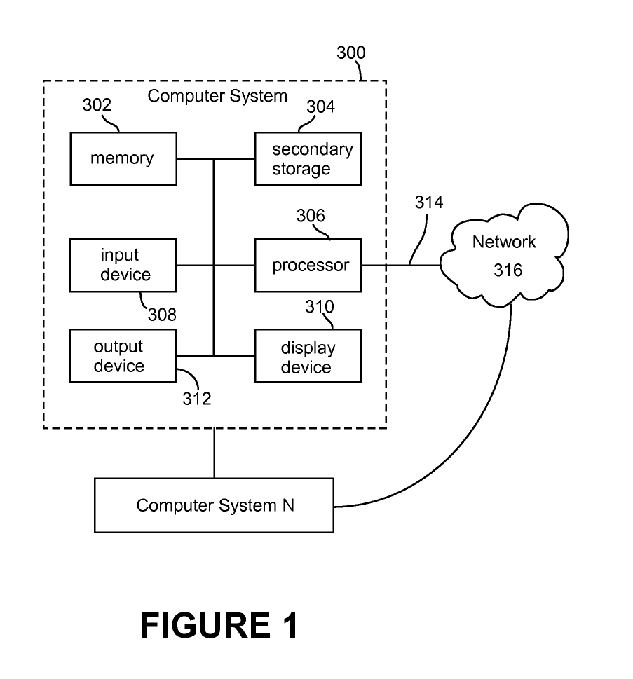

FIG. 1 shows a block diagram of a computer system 300 that may be used to execute the methods described herein. The processes described herein may be implemented as software programs and/or program modules executed by a processor. Computer system 300 may include a memory 302, a secondary storage device 304, a processor 306, an input device 308, a display device 310, and an output device 312. Memory 302 may include RAM or similar types of memory and it may store one or more computer programs for execution by processor 306. The computer programs may include instructions for executing the processes described herein. Secondary storage device 304 may include a hard disk drive, floppy disk drive, CD-ROM drive, or other types of non-volatile data storage. Processor 306 executes the application(s), which is stored in memory 302 or secondary storage 304, or received from the Internet or other network. Input device 308 may include any device for entering information into computer system 300, such as a keyboard, mouse, cursor-control device, touch-screen, microphone, digital camera, video recorder or camcorder. Display device 310 may include any type of device for presenting visual information such as, for example, a computer monitor or flat-screen display. Output device 312 may include any type of device for presenting a hard copy of information, such as a printer, and other types of output devices include speakers or any device for providing information in audio form. Computer system 300 may store a database structure in secondary storage 304, for example, for storing and maintaining information needed or used by the application(s). Also, processor 306 may execute one or more software applications in order to provide the functions described in this specification, specifically in the methods described above and below, and the processing may be implemented in software, such as software modules, for execution by computers or other machines. The processing may provide and support web pages and other GUIs. The GUIs may be formatted, for example, as web pages in Hypertext Markup Language (HTML), Extensible Markup Language (XML) or in any other suitable form for presentation on a display device.

Referring again to FIG. 1, the computer system 300 may also include a network adaptor or other connection 314 for coupling computer system 300 to the Internet or other network(s). Through network connection 314, computer system 300 may connect to the Internet 316, for example, in order to perform the methods described herein. The computer system 300 may include a computer, handheld device, laptop, or other device with one or more components of components of computer system 200.

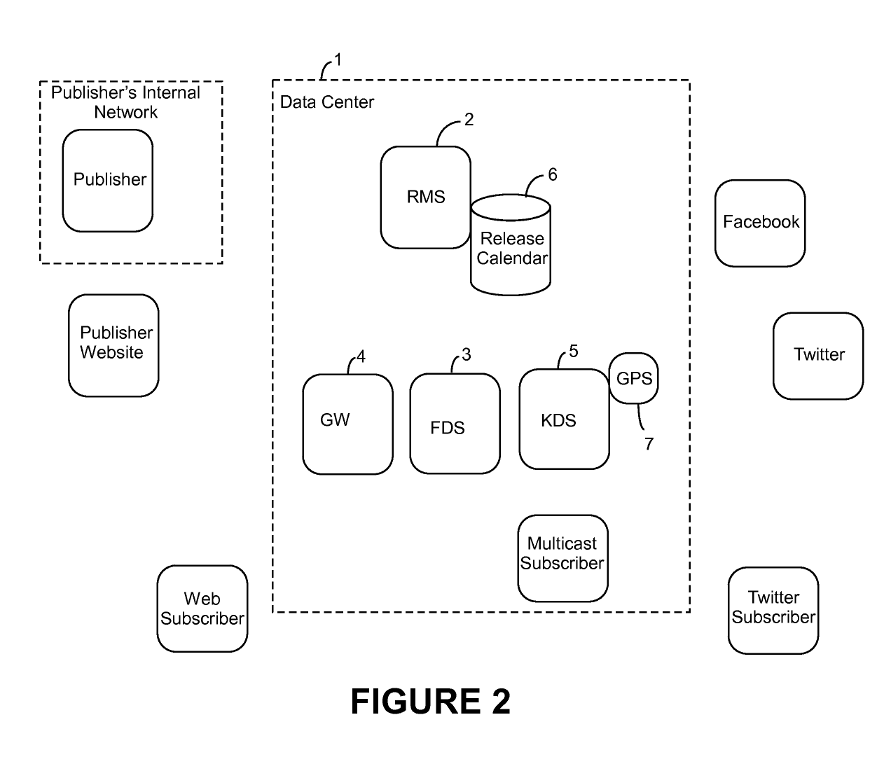

FIG. 2 illustrates a system in accordance with an embodiment. The system may include a Data Center (DC) 1 that is configured to deliver and/or transmit information and a release key to one or more receiving devices and/or recipients. The DC 1 may include any combination of hardware and/or software. A Release Management Server (RMS) 2, one or more File Distribution Server(s) (FDS) 3, a Gateway Server (GWS) 4 and one or more Key Distribution Servers (KDS) 5. The RMS 2, the FDS 3, the GWS 4, and KDS 5 may be any combination of hardware and/or software, and may be physically located at or near the same site or may be located at different sites depending on the configuration. In one embodiment, one or more of the components of the DC 1 is secured by any suitable commercial resource. Some examples may include hosting the DC 1 by Equinix® or Savvis®. In one embodiment, one or more of the components of the DC 1 may include a network connection to a private and/or public network. Suitable network connections include those to the Internet.

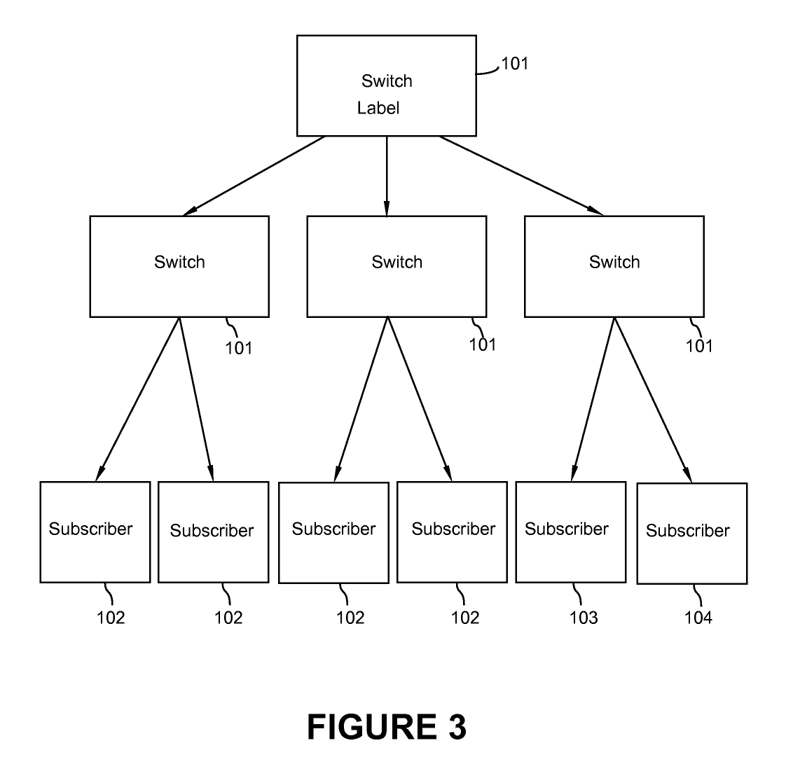

FIG. 3 illustrates the KDS 5 in an embodiment. The KDS 5 may be coupled to one or more switches 101 that may be arranged as a two-layer cascade with trunking at the first layer. In another embodiment, one or more switches capable of supporting multicast or broadcast may be used. In one embodiment, the switches 101 may support multicast or broadcast traffic with low latency. Additionally, the switches may have a small port-to-port latency, thereby allowing the switches to be configured to deliver data to a subscriber device 102 at on or about the same time. In one example, the switches 101 may handle multicast or broadcast traffic at 10 gigabits per second (Gbps) or faster, have internal latencies of under 1 microsecond for a 300 byte packet, and have the ability to deliver incoming multicast or broadcast traffic to all subscribed recipients' ports within the same microsecond. Several commonly available switches meet this requirement including the Blade Networks G8124 RackSwitch.

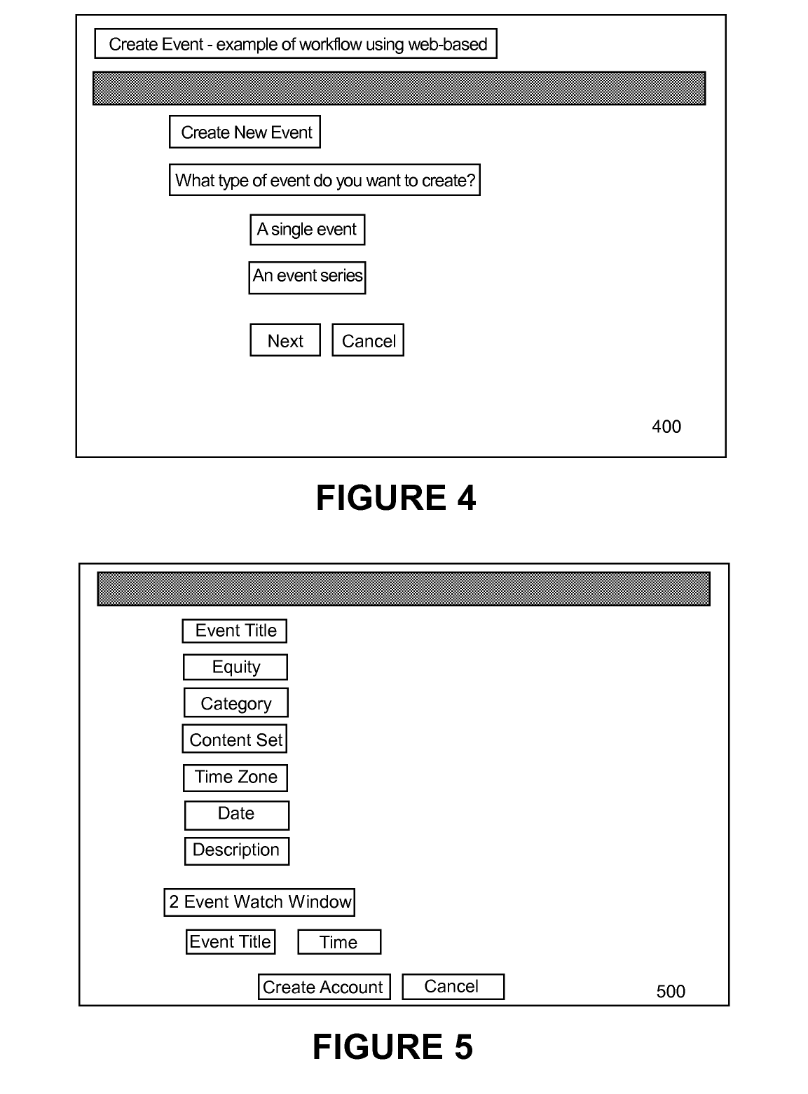

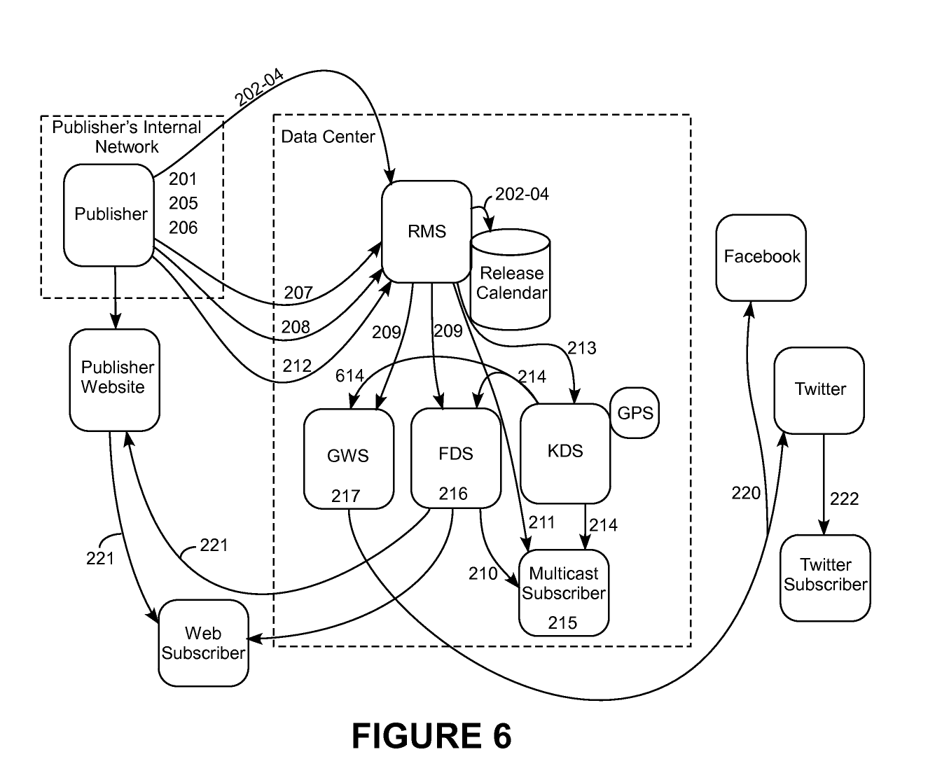

FIGS. 4 and 5 show an example workflow for entering an event in an embodiment. As shown in FIG. 4, a window 400 may be presented and enable an automatic or user based entry for an event to be released. FIG. 5 shows a window having fields that may be completed automatically or by user intervention describing the type of event, timing, and other relevant information including the timing of the event.

Referring again to FIG. 2, the KDS 5 may be configured with an internal or external timing mechanism. In one embodiment, the timing mechanism may be a Global Positioning System (GPS) 7, which includes a signal and GPS time code receiver. In one embodiment, GPS 7 may be used to synchronize one or more clocks of one or more computing devices with the atomic clocks carried by one or more GPS satellites. In one embodiment, the GPS time code receiver may be a Spectracom NetClock 9389.

In one embodiment, the KDS 5 may be replicated in one or more locations. One or more of the KDS 5 may be synchronized with the timing mechanism discussed above. In this way, the information sent from each KDS 5 may be transmitted about or about the same time to one or more recipients. FIG. 2 illustrates the RMS 2, which may be configured to be accessed remotely or locally by a publisher using, for example, the computing device and/or system of FIG. 1. In one embodiment, a publisher of information may access the RMS 2 through an interface, such as the interface shown in FIGS. 4 and/or 5. In another embodiment, a publisher may access the RMS 2 on a local computing device, which may be located behind a company firewall.

As discussed above, publishers of information may be verified. As part of the verification process, the system may assign a public/private key pair to the publisher. They key pair may be stored and/or maintained in the RMS 2. Any suitable process used to generate the public/private key pair may be employed. For example, one public key cryptography process that may be used includes RSA—Rivest, Shamir and Adleman.

Referring again to FIG. 2, the RMS 2 may be configured to distribute one or more encrypted files to the FDS 3 in advance of a public release. The RMS 2 may also be configured to deliver one or more release keys to the KDS 5. The KDS 5 may be configured to deliver one or more release keys to recipients via dedicated, low latency multicast or broadcast networks. Other networking protocols may be used including TCP/IP. In one embodiment, the KDS 5 may deliver one or more release keys to the FDS 3 via the same multicast or broadcast networks, where the files for that release will be decrypted for delivery to recipients who are not connected to the multicast or broadcast network or who do not wish to perform decryption themselves.

Depending on the configuration, the system may include a single global RMS 2 or a RMS 2 may be configured at each virtual or physical site for increased redundancy. In a similar manner, any of the components shown in DC 1 may be configured at various sites for increased redundancy and to enable transmission of keys for sources closer to a recipient. This eliminates the delays associated with a central point of transmission, as discussed above. In the latter case, the encrypted files and associated release keys may be replicated between the different RMS 2 using a secure channel, such as the Secured Sockets Layer (SSL).

The FDS 3 may be configured to receive encrypted documents and/or files from the RMS 2 before the release key and then decrypt those documents and/or files when a release key is received from the KDS 5. The FDS may also be configured as a file server that provides read-only access to the general public to a collection of files using standard Internet protocols, such as Hypertext Transport Protocol (HTTP) and File Transfer Protocol (FTP). These files include both the encrypted and unencrypted release documents. In addition, the FDS may include a release calendar 6, which identifies when certain documents may be publicly released. In one embodiment, the release calendar 6 may be updated and/or maintained by the RMS 2. The FDS 3 may be configured to push encrypted and decrypted files to subscribers and/or subscriber devices via FTP.

The GWS 4 may be configured to receive encrypted documents from the RMS 2 before the release and decrypt those documents when the GWS 4 receives a release key from the KDS 5. The GWS 4 may be configured to transmit the documents to external distribution channels, such as Twitter® or Facebook®. The GWS 4 may operate to transmit information in accordance with the release calendar 6.

The system may support any type of information in any type of form. For example, the system may be configured to support a plain text document, an HTML document, a structured data format like XML, a proprietary binary format, an image, a video clip or any other format that may be represented in a data file. When submitting a document to the system, the publisher and/or the publisher's computing device generally follows the following process. First, the content type is provided. Second, an encoding and/or format of the document is provided. In one embodiment, the encoding and/or format may be selected from a list of supported content types and encodings defined by the system. Common format and/or encoding types may be found in RFC 2046. The content type, encoding and format of the document are all public metadata elements, and are visible prior to release. In one embodiment, a publishing tool may automatically detect content type, encoding and format from the publisher's original document.

In an embodiment, the system may be configured to support many different types of content. In one example, human readable content may be supported, such as in HTML, XHTML, plaint text, PDF, or other similar formats. In another example, the system may be configured to support machine readable structured data, such as in XML, CSV, JSON, or various binary formats. In this example, publishing tools (both the web based on locally installed versions) may be used to provide publishers with standardized templates that enable the publisher to generate a machine-readable summary document for many common release types, such as corporate earnings and economics. The tools also provide a standard set of metadata to identify the data and ensure that recipients may unambiguously interpret it. Additionally, the system may be configured to support legacy news syndication formats, such as in NewsML or NITF.

As discussed above, the system is configured to support metadata, which may include two forms: a finite set of name-value pairs called tags and a finite set of names for which the value is unconstrained called properties. The list of available tags and property names may be maintained in a metadata database on the RMS 2. In the system, tags and properties may be applied to releases, files, and to specific fields within files that use a structured data format (such as XML or JSON).

An example of a tag may be “category=earnings announcement.” This tag may be applied to releases or files which are related to a company earnings announcement. Likewise, the tag “measure=revenue” may be applied within a structured file to indicate that a certain field contained a value for revenue. The tag “format=XML” is a tag that may be applied to a file to indicate its format. An example of a property may be “title=Acme Corp Earnings Announcement” in which case the property name “title” is standardized, while the value “Acme Corp Earnings Announcement” is defined by the publisher.

The RMS 2 may be configured to define a set of tags and property names for use within the system and indicates which are mandatory or optional for each context (release, file, internal file content). The publishing tools may enable a publisher or a publisher's computing device to apply the appropriate metadata prior to a release.

As discussed above, metadata which is applied to the release or to a specific file is visible to all recipients prior to the release and is considered to be public metadata. Examples might include the title of a document or the category of a release. Recipients or their computing devices may be configured to use public metadata to filter the available files, for example, by discarding those in which the release has the tag “category=product announcement,” while processing those which have the tag “category=merger announcement.”

In one embodiment, certain tags and properties may be limited to specially privileged administrators of the system or may be subject to editorial review.

The system may support content sets and/or entitlements. As discussed above, the web (HTTP pull), FTP pull, and social media delivery of data may be supported by the system and are generally available to all recipients with access to the Internet or the specific social media platforms. On the other hand, delivery of data via FTP push, HTTP push and direct multicast or broadcast may be limited and considered premium content delivery mechanisms, which have higher associated costs and thus are offered as a fee-based service. The system provides the following mechanisms to manage entitlements to these premium delivery mechanisms.

Content sets are privileged tags (in the form “content set= . . . ”) which cannot be applied by a publisher but rather are applied by an administrator of the system (or via a set of rules defined by an administrator). A content set tag may be applied to releases to indicate that the release is a part of that content set. Content set tags cannot be applied to files or used within files. A release may or may not be part of more than one content set. The content set tag is visible to recipients and publishers.

A table of entitlements may be configured in the RMS 2 and defines lists of recipients and the content sets that they may receive via FTP push, HTTP push or multicast or broadcast. FTP push recipients may be set up in advance and provide a host, port, user name password to which files should be delivered at the time of the release. HTTP recipients may need to provide a host, port and optional user name and password for the HTTP push. The FDS uses the contents of this table to determine which files should be delivered to which addresses via FTP/HTTP.

The delivery of release keys via multicast or broadcast may be managed in the entitlements table. In one embodiment, an additional table in the RMS 2 may be configured to map content set to multicast or broadcast group, such that every content set is assigned to a unique multicast or broadcast group. The network devices to which multicast or broadcast recipients are coupled may be configured to enable that recipient to subscribe only to the multicast or broadcast groups for which they are entitled to the corresponding content set.

The system may include one or more of the following. First, the releases may be numbered sequentially (e.g. 1, 2, 3 . . . ) such that there are no gaps and that each new release is assigned the next number in sequence. The highest number assigned may be made available to one or more recipients via a special file on the FDS 3 and/or by publishing a message via multicast or broadcast from the KDS 5, which includes the highest release number as well as a timestamp. The timestamp may be updated at regular intervals. In this manner, a recipient may determine the highest release number currently in use. Because the release numbers are assigned sequentially, the recipient may thus determine whether it has received all releases or if any have been missed (and thus may be requested again from the FDS 3). The timestamp may be periodically updated enables the recipient to determine that they are viewing the most recently updated information.

In order to facilitate distributed management of releases, for example, in an embodiment in which there is more than one RMS 2, the release sequence numbers may be prefixed with another identifier which may identify a site or instance of an RMS. In such manner, the release numbering may be partitioned arbitrarily and the same sequential ordering may be applied to the releases within each partition. In this embodiment, the process for a recipient may be the same as described above, but with the additional requirement that the latest sequence number be published for each partition and with the recipient likewise verifying receipt on a per-partition basis.

A file in a release may be assigned a sequential file number and the highest file number for a given release may be made available from the FDS 3 and/or via the KDS 5. The highest file number for a release may be recorded along with a timestamp for each release. The recipient may determine that they have received every file for a given release.

In one embodiment, the above release numbering and file number system may be used in conjunction with another technique for notification of new content (such as RSS) to make the process reliable, efficient and easy to use for the recipient.

Referring again to FIG. 2, an example of a method of a release is described. It should be noted that not all steps need to be performed in the process below. For example, 203, 204, 210, 211, 218, 219, 220, 221 and 222 may be optional in some cases. In addition, not all steps below need to be performed in any sequential order. For example, steps 218, 219, 220, 221 and 222 may be performed in any order or at about the same time. In step 201, a publisher or a publisher's computing device may create information for delivery. In step 202, a publisher may define a release in the system. The release may consist of one or more than one files, each with a unique file number. The date and time of the release may be defined at this time or a later time. The RMS 2 may be configured to define a new, permanent and globally unique release identifier to identify the release. The release identifier may be unique within the system and may further be sequential as described above to facilitate detection of missing or updated releases by recipients.

The request for the release can be made via a web-based user interface to the RMS 2 or via a request from software running on the publisher's computing device to the RMS 2. If the release is to be associated with a verified publisher, then the publisher may sign the request for the release with his private key. This allows the system to verify the identity of the publisher and associates the publisher's identity with the release.

In step 203, the publisher may associate certain public metadata with the release or with certain files in the release which is visible prior to the release time itself.

In step 204, the files associated with the release may be automatically associated with a static Universal Resource Locator (URL) based on the release identifier and document number. The publisher may embed this URL in the publisher's website. In one embodiment, the publisher may associate certain files within the release with a social media platform. The publisher may associate an existing social media account with the release using the delegated authorization Application Program Interface (API) provided by a social media platforms, and designate which files were to be published to that platform. The RMS 2 may store the delegated authorization token along with the release.

In step 205, a publisher may generate a release key, which may be a symmetric key to be used both to encrypt and decrypt the file(s) that are part of the release. Any suitable process may be used to generate the release key, such as the United States Government's Advanced Encryption Standard, Blowfish®, or other similar processes. The publisher may use their own software to generate the key or they may request that the RMS 2 generate a key for them using the web user interface.

In step 206, the publisher may encrypt each file in the release using the release key. After encrypting each file, a verified publisher may compute and sign a message digest using the private key which is appended to the file. Non-verified and anonymous publishers cannot sign their files.

In step 207, the publisher or the publisher's computing device may upload the encrypted files to the RMS 2. This request may be made via a web based interface or from software running locally on a publisher's computer. The release key may be uploaded in a similar way at the same time or, for added security, retain the release key until shortly before the actual release time. By retaining the release key, it is ensured that no recipient may obtain the contents of the encrypted files, even if the system is compromised.

In step 208, the publisher may set the time for the release. The system may calculate two other times: the file staging time and the key staging time. The file staging time may be defined as when the RMS 2 transmits the encrypted files to the FDS 3, and may be any range of time. In one example, the file staging time may be several minutes in advance of the release. In one embodiment, the file staging time may be a sufficient amount of time to allow delivery from RMS 2 to the FDS 3 and from FDS 3 to recipients or a recipient's computing device. In one example, the file staging time is sufficiently small so as to not allow a malicious recipient to decrypt the file without the release key.

A key staging time may be defined as the time when the RMS 2 transmits the keys to the KDS 5. In one example, the key staging time may be enough time for all KDS to receive the key prior to the release and may be any period of time. In one example, the key staging time may be only a few seconds before the release time.

In step 209, the file staging time is reached and the RMS 2 may transmit the encrypted files to the FDS 3. It should be noted that the files may be sent from any of the RMS 2 instances to any of the FDS 3 instances. In this way, if any RMS 2 or FDS 3 is unavailable, the files will still be accessible.

In step 210, recipients who wish to receive the encrypted files may query the FDS 3 using HTTP or other common means of requesting files over the Internet. Alternatively, the FDS 3 may push the files to certain recipients using FTP. Recipients may be able to choose which files to receive based on public metadata associated with certain files.

In step 211, recipients may request the public keys for verified publishers from the RMS 2. In this way, if a recipient receives a file which has been signed, it may obtain the asserted publisher's public key, decrypt the attached digest, compute its own digest of the encrypted file and compare the two digests. If there is match, then the recipient may be assured that the encrypted file contains data that originated with the verified publisher.

In step 212, the publisher uploads the release key to the RMS 2. This can be accomplished using the RMS's 2 web based user interface and common secure transmission protocols, such as SSL (Secure Sockets Layer). This step may be performed prior to the key staging time. If the publisher has not sent the key to the RMS 2 by this time, the release may be postponed and a new release time and key staging time may be set. In one embodiment, the encrypted files may have been staged to the FDS 3 and delivered to the recipients. The file staging time may not change.

In step 213, the key staging time may be reached and the RMS 2 may transmit the release key to the KDS 5 via a secure transmission protocol, such as SSL. As with the encrypted file transmission, the key transmission may be from any RMS 2 to any KDS 5 to ensure reliability, even in the case of hardware or network failures. Included in the message from the RMS 2 to the KDS 5 may be both the release key and the release time. The KDS 5 receives the key and waits until the release time.

In step 214, the KDS 5 may be configured to wait to release time before transmitting the release key message. The release key message may be is a User Datagram Protocol (UDP) packet whose payload consists of an identifier of the release and the release key itself. In one embodiment, the message may be very small. For example, the message may include 16 bytes for the release identifier, 8 bytes for the release timestamp and 256 bytes for a typical release key length for a total UDP payload of 280 bytes, and thus,may be transmitted to multicast or broadcast recipients within approximately 5 microseconds with less than 1 microsecond variance between recipients using current technology. In one embodiment, the multicast or broadcast group to which the key is published may be provided by the content set to which the release is assigned. If the release has no assigned content set, then the key may be published to the default multicast or broadcast group.

In step 215, a multicast or broadcast recipient, upon obtaining the key, may match it with the specified release using the release identifier and then decrypt the files associated with that release.

In step 216, at or about the same time, the FDS 3, which may subscribe to all multicast or broadcast groups, may obtain the key from the KDS 5 via a multicast broadcast message, decrypt the associated files, and store them locally in the FDS 3. In step 217, the GWS 4, which may subscribe to all multicast or broadcast groups, may obtain the release key from the KDS 5 via multicast or broadcast message and decrypt the associated files.

In step 218, the FDS 3may transmit decrypted files to recipients configured to receive decrypted files via HTTP push or FTP push. The determination of which files should be sent to which recipient is based may be on entitlements.

In step 219, any recipient may request the decrypted files via HTTP pull or FTP pull using a URL constructed from the release identifier.

In step 220, those files in the release that may have been designated for dissemination via a social media platform may be released by the FDS 3.

In step 221, recipients who may request to view the release page on a company's public website may be directed to the URL hosted by the FDS 3. If the information is embedded in an inline frame (iframe), the information may be transparent to the website viewer.

In step 222, social media users, such as those on Twitter® and/or Facebook®, may view the updated content in the release.

Although the system is depicted with various components, one skilled in the art will appreciate that the servers can contain additional or different components. In addition, although aspects of an implementation consistent with the above are described as being stored in memory, one skilled in the art will appreciate that these aspects can also bestored on or read from other types of computer program products or computer-readable media, such as secondary storage devices, including hard disks, floppy disks, or CD-ROMor other forms of RAM or ROM. The computer-readable media may include instructions for a controlling a system to perform a particular method described herein.

The foregoing description of implementations has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

1. A method, comprising:
providing encrypted information to a plurality of receiving devices; and
transmitting by one of a multicast and broadcast a release key to the plurality of receiving devices to enable access to the encrypted information, wherein the release key is received at or about the same time by the plurality of receiving devices.

2. The method of claim 1 further comprising transmitting the release key over a multicast or broadcast network.

3. The method of claim 1 further comprising transmitting the release key over a distributed network.

4. The method of claim 1 further comprising synchronizing the transmission of the release key using a timing mechanism.

5. The method of claim 1 further comprising providing a verification of a publisher of the information.

6. A computer program product, stored on a non-transitory computer readable medium, comprising instructions that when executed on one or more computers cause the one or more computers to perform operations, the operations comprising:
receiving encrypted information at a plurality of receiving devices; and
receiving by one of multicast and broadcast a release key at the plurality of receiving devices to enable access to the encrypted information, wherein the release key is received at or about the same time by the plurality of receiving devices.

7. The computer program product of claim 6 further comprising receiving the release key over a multicast or broadcast network.

8. The computer program product of claim 6 further comprising receiving the release key over a distributed network.

9. The computer program product of claim 6 further comprising one of pushing or pulling the encrypted information to the plurality of receiving devices.

10. The computer program product of claim 6 further comprising receiving a verification of a publisher of the encrypted information.

11. A system, comprising:
a Key Distribution Server (KDS) configured to provide a release key to a plurality of receiving devices, the release key enabling access to encrypted information;
one or more switches coupled to the KDS and configured to distribute the release key by one of a multicast or broadcast to the plurality of receiving devices; and
a timing mechanism coupled to the KDS and configured to ensure delivery of the release key to the plurality of receiving devices at or about the same time.

12. The system of claim 12 further comprising a Release Management Server (RMS) configured to provide the release key to the KDS.

13. The system of claim 12 wherein the RMS further comprises one or more databases for storing a plurality of tags and/property names.

14. The system of claim 11, wherein the timing mechanism includes a Global Positioning System (GPS).

15. The system of claim 14, wherein the RMS includes an entitlements table.

16. A system, comprising:
one of a File Distribution Server (FDS) and Gateway Server (GWS) configured to receive encrypted information at a file staging time and receive a release key to access the encrypted information at a key release time, wherein the release key is received by one of a multicast or broadcast from a Key Distribution Server (KDS).

17. The system of claim 16, wherein the encrypted information is released based on a release calendar.

18. The system of claim 16, wherein the encrypted information is pushed or pulled to one or more receiving devices.

19. The system of claim 16, wherein the release key is a symmetric key.

20. The system of claim 16, wherein the one of FDS and GWS are configured to communicate with one or more multicast or broadcast groups.
